(19) United States
(12) Patent Application Publication
(10) Pub. No.: US 2018/0102734 A1
(43) Pub. Date: Apr. 12, 2018

(54) METHOD AND SYSTEM FOR MOUNTING PHOTOVOLTAIC CELLS TO CREATE SHADE AND ELECTRICITY

(71) Applicant: SAMUEL DAVID KATZ, Acworth, GA (US)

(72) Inventor: SAMUEL DAVID KATZ, Acworth, GA (US)

(21) Appl. No.: 15/289,493

(22) Filed: Oct. 10, 2016

(51) Int. Cl. H02S 30/20; E04F 10/06; E04F 10/10; H02S 40/38; H02S 20/22

(52) U.S. Cl. CPC H02S 30/20; E04F 10/06; H02S 20/22; H02S 40/38; E04F 10/10

(57) ABSTRACT

A method and system for creating a shaded area using retractably mounted photovoltaic cells is disclosed that utilizes an energy and shade producing canopy of retractable photovoltaic cells or panels that is deployed to create shade and electricity when desired and retracted when not in use.

### BACKGROUND OF THE INVENTION

### 1. Field of the Invention

This invention generally relates to a method and system for creating a shaded area using retractably mounted photovoltaic cells and more particularly to a method and system for producing both shade and electricity that utilizes an energy and shade producing canopy of retractable photovoltaic cells or panels that is deployed to create shade and electricity when desired and retracted when not in use.

### 2. Background Discussion

It is known to use shade producing devices such as window sunshades and awnings to create a shaded area and/or to control heating by the sun of a residence, business, outdoor porch or recreational area, beach or picnic area and the like. Traditional shade producing devices are passive in nature and are not adapted to produce energy from the sun. Generally, they use a fabric or vinyl canopy which blocks sunlight to create shade. The canopy can be permanently fixed in place to create a shaded area; however, the sunshade or awning can also be retractably mounted so that it can be deployed when needed and retracted to a stored position when desired. Historically, photovoltaic cells for generating electricity directly at the consumer location have taken the form of rigid solar panels that are mounted on fixed supports on the roof of a residential or business structure. Because the solar panels cannot be retracted to a safe position, they are exposed to potential damage during severe weather situations such as hail, high winds or heavy precipitation.

Recently, flexible solar panels have been created using, for example, Gallium arsenide (GaAs) semiconductors, with a thickness of approximately 1 micron. This is achieved by using a transfer printing method that does not require an interlayer adhesive, allowing for the decrease in thickness. The GaAs solar microcells are held temporarily to a film stamp using a layer of photoresist. The backside of the cells contains the bottom electrode, which is applied via an e-beam evaporator.

The cells are brought into direct contact with the substrate electrode, which is deposited on a polyimide film. A pressure of 80 kPa is applied to the structure for 20 minutes at 170° C., allowing for bonding between the electrodes as well as melting of the photoresist, which creates a protective layer against delamination. The film stamp can then be peeled away, and the photoresist removed with acetone, leaving behind the ultrathin solar cell.

This method, as well as the structure of the GaAs cells themselves, allows for the incredible thinness of these cells. In particular, the base layer of the solar cell, usually 2-4 microns in thickness, has been reduced to a thickness of 0.7 microns, and the bottom contact layer, also usually 2 microns in thickness, has been reduced to 0.1 microns. Despite this reduction in thickness, the 1.04 micron vertical-type cells perform at an efficiency of 15.2 percent, an improvement over the 14 percent efficiency of typical 4.24 micron cells. Because of their reduced thickness, these cells experience much less strain when they are bent, and they can be bent around objects as small as 1 mm in thickness. The research is published under the title “Ultra-thin flexible GaAs photovoltaics in vertical forms printed on metal surfaces without interlay adhesives” in the journal Applied Physics Letters.

### BRIEF SUMMARY OF THE INVENTION

Accordingly, it is one object of the present invention to replace the passive shade canopy of a traditional shade producing device with photovoltaic cells to create an active, solar shade canopy for producing both shade and electricity from sunlight.

Another object of the present invention is to provide a method and system for producing shade and electricity that utilizes a solar shade canopy of retractable photovoltaic cells that are deployed to create shade and electricity when needed and retracted to a protected, stored position when desired.

Yet another object of the present invention is to provide a method and system for retractably mounting photovoltaic cells so the cells can be retracted to a protected, stored position to prevent damage during heavy weather events.

In one embodiment of the present invention, the method for producing shade and generating electricity of the present invention includes the steps of: 1) deploying a retractable solar shade canopy having photovoltaic cells for producing electricity from light to create a shaded area; 2) utilizing the deployed canopy to generate electricity from sunlight and to cool the shaded area; and 3) retracting the canopy to a stored position when desired.

According to a further embodiment of the invention, the method includes the step of using at least one sensor to determine when to deploy or retract the solar shade canopy to optimize the generation of electricity and cooling of the shaded area.

In one embodiment of the present invention, the system uses a retractable solar shade canopy made from one or more flexible sheets having flexible photovoltaic cells. In this embodiment, the system takes the form of a sunshade that can be retractable positioned internally or externally at a window of a building, for example, in the form a cord or string retractable window shade, or a roll-up window shade. Alternatively, the system can take form of a retractable awning that can be positioned over a space outside of and/or adjacent to a structure, such as a porch, patio, deck, swimming pool, roof or dining area or externally at a window or door of a structure.

In yet another embodiment of the system of the present invention, the solar shade canopy is made from a plurality of retractable rigid solar panels that can be unfolded to a deployed position and folded to a stored position. In this embodiment, a track system is established over the area to be shaded such as a porch, patio, deck, swimming pool or dining area or externally at a window of a structure and/or where the system is to be operated, such as on a roof of a structure.

Axles with wheels are mounted on the tracks and the wheels are fixed directly to the axle (and not to a hub assembly) so that the wheels and axle move dependently and proportionately to one another. On each axle is mounted a sleeve that moves independently of the axle and wheel assembly. Attached to the sleeve is a solar panel except for the wheel and axle at the front which can have a motor or a draw string attached to it and is used to deploy or retract the solar shade canopy made from the rigid solar panels. Each sleeve has two slits that expose the axle it covers. Ropes or chains run from the hanging end of one solar panel (when in the vertical position) attach to the axle in front of it through the slits in the sleeve. As the axle rolls forward being pulled by the movement of the axle at the front, the ropes attached to each axle wind themselves around their respective axles and draw the end of the solar panels up into a horizontal position. The length of each rope or chain must equal the total rotational distance it will travel and cannot be less than the total length of the solar panel frame assembly.

Alternatively, instead of using ropes, the rigid solar panels can be hinged to one another and folded and unfolded in an accordion-like manner.

Each rigid solar panel can be connected in either series or parallel and then connected to directly to the electrical system of the structure using a grid tie inverter or to a battery. The deployment and retraction of the system can be automated using a microcontroller for controlling the motor that drives the system, the microcontroller being connected to a timer or a light sensor and motion sensor. The microcontroller's logic can be used to start and stop the deployment and retraction of the system automatically by controlling the motor in conjunction with inputs from the sensors.

The microcontroller uses the light sensor to determine when to deploy and retract the solar panels and the motion sensor determines the shade canopy's location so the microcontroller can drive the motor to make adjustments to the position of the solar shade canopy as needed. The system can have programmed preset, stop-locations as well as emergency stop features for safety. A wind sensor can also be used as a method of determining if a system needs to be retracted to prevent damage to the photovoltaic cells.

### BRIEF DESCRIPTION OF THE SEVERAL VIEWS OF THE DRAWINGS

FIG. 1 illustrates one embodiment of the system of the present invention wherein the solar shade canopy for producing shade and electrical energy from sunlight comprises one or more flexible sheets of photovoltaic cells;

FIG. 2 schematically illustrates another embodiment of the system of the present invention wherein the solar shade canopy for producing shade and electrical energy from sunlight comprises a plurality of rigid solar panels that can be unfolded to a deployed position and folded to a stored position;

FIG. 3 illustrates the system of FIG. 2 positioned in the stored position;

FIG. 4A illustrates one embodiment of the canopy deployment mechanism of the rigid solar panel system in the stored position;

FIG. 4B illustrates the canopy deployment mechanism shown in FIG. 4A in the fully deployed position;

FIG. 5A and FIG. 5C are front view and side views respectively illustrating the wheel used with the unique axle employed by the canopy deployment mechanism;

FIG. 5B illustrates the wheel attached to the unique axle having grooves for receiving the ropes used by the canopy deployment mechanism;

FIG. 6A is a top planar view of the rotatably mounted sleeve on the axle showing the attachment mechanism and the slots of the sleeve positioned over the grooves of the axle;

FIG. 6B is a front view of the rotatably mounted sleeve on the axle;

FIG. 6C is a side view of FIG. 6A showing the rope or chain which wraps around the axle passing through the slot in the sleeve;

FIG. 6D is a side view of FIG. 6B showing the attachment arrangement of the sleeve;

FIG. 7A is a top planar view of the sleeve showing the slots and attachment arrangement FIG. 7B is a side view of the sleeve;

FIG. 7C is a top view illustrating the solar panel support frame which is pulled up to the deployed position by the ropes that wrap around the axles as the wheels move down the railing of the deployment mechanism;

FIG. 7D is a side view of the solar panel support frame showing the loops used to attach the rope to the frame;

FIG. 8A illustrates yet another embodiment of the canopy deployment mechanism of the rigid panel system folded in the stored position in an accordion-like manner;

FIG. 8B illustrates the canopy deployment mechanism shown in FIG. 8A in the fully deployed position;

FIG. 9 is a top planar view showing two rigid solar panels supported in support frames that are hinged together and have wheels at either end;

FIG. 10A and FIG. 10B are top and side views respectively of the axle and wheel combination of the support frames;

FIG. 11A and FIG. 11B are top and side views respectively of the attachment members that attach the axles to the support frames;

FIG. 12A and FIG. 12B are top and side views respectively of the hinge; and

FIG. 13A and FIG. 13B are top and side views respectively of the support frame.

### DETAIL DESCRIPTION OF THE DRAWINGS

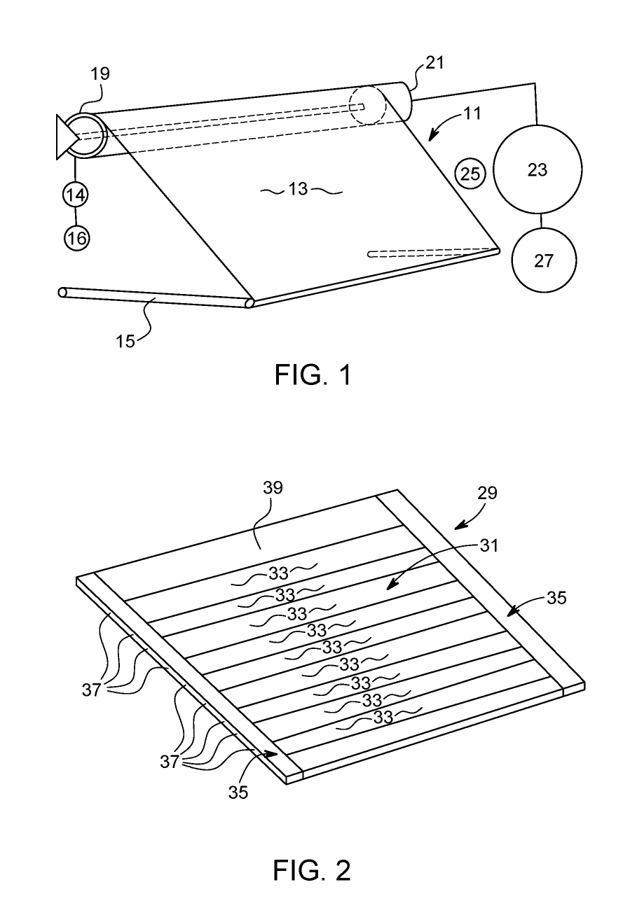

Referring to FIG. 1, a first embodiment of the electrical energy producing sunshade system of the present invention is generally indicated at 11. In this embodiment, the system 11 uses a retractable electrical energy producing sunshade canopy comprising a flexible sunshade canopy 13 having one or more flexible photovoltaic cells such as disclosed, for example, by the article referenced in the Background of the Invention. In that regard, the flexible electrical energy producing sunshade canopy 13, according to one embodiment thereof, comprises a vinyl or canvas sheet which blocks sunlight and acts as the support substrate for the flexible photovoltaic cells which are positioned on top of the sheet. The photovoltaic cells can be connected in parallel or series. The cells are electrically connected to a charge controller 14 to control the charge from the cells and a battery 16 collects the charge from the cells for later use. Alternatively, the photovoltaic cells can be plugged directly into the electrical system of the residential or business structure associated with the system using a grid tie inverter.

A collapsible frame 15 which, for example, is pivotally mounted on an exterior wall of the residential or business structure, supports the canopy 13 at a deployed position for generating electricity from sunlight and creating a shaded area as shown in FIG. 1. A canopy deployment and storage mechanism, generally shown at 17, is also provided for moving the flexible, electrical energy producing sunshade canopy 13 between the deployed position as shown in FIG. 1 and a protected, stored position wrapped around roller 19. An electrical connection (not shown), according to one embodiment, is provided at the roller 19, for example, along the axis of rotation, to connect the photovoltaic cells on the canopy 13 to the charge controller 14 or grid tie inverter.

The mechanism 17 has a driver 21, such as a hand crank or motor for rotating the roller 19 forward or backward in order to deploy or retract the flexible canopy 13 in cooperation with the collapsible frame 15. When the canopy 13 is in the stored position and wrapped around the roller 19, the frame 15 pivots upward to the collapsed position flush with the exterior wall of the structure. It should be noted that the collapsible frame 15 and mechanism 17 shown in FIG. 1 are by way of example only and other collapsible frames and deployment mechanisms, as are known in the art of sunshades and awnings, are envisioned for use with the flexible electrical energy producing sunshade canopy 13 of system 11.

In that regard, the system 11 of FIG. 1 can take a variety of forms, such as, for example, a retractable solar sunshade that is positioned internally or externally at window of a building, for example, a string-retractable window shade, or a roll-up window shade to control the amount of sunlight allowed to be transmitted into the interior of the structure and to produce electricity from sunlight. Alternatively, the system 11 can take form of a retractable awning that can be positioned over a space to create a shaded area outside of and/or adjacent to a structure, such as a porch, patio, deck, swimming pool, or dining area or externally on the roof or at a window or door of a structure.

A microcontroller 23 is employed to control the motor 21 of mechanism 17 and is preferably connected to a motion sensor 25 for sensing the position of the canopy 13 during deployment and retraction and to determine the shade canopy's location. The motion sensor 25 can also be used by the microcontroller's logic to assist in positioning the canopy at pre-set, stop-locations as well as emergency stop features for safety.

According to a further embodiment of the present invention, deployment and retraction of the system 11 is automated and the microcontroller 23 is connected to at least one of a light, temperature, and/or wind sensor generally shown at 27. In this embodiment, the microcontroller's logic can be used to open and close the system 13 automatically by controlling the motor 21 in conjunction with inputs from the sensors 27 to optimize electrical generation and cooling from shade as well as to retract the system 11 to prevent damage from hazardous weather conditions. The logic of the microcontroller 23 uses the inputs from the light, temperature and/or wind sensors at 27 to determine when to deploy and retract the canopy 13 for optimum electrical generation and cooling depending on current weather and the wind sensor can also be used as a method to determine if the system needs to be retracted to prevent damage to the photovoltaic cells.

In addition, the canopy deployment mechanism 17 can be computer controlled and integrated into the heating/cooling system (not shown) of the structure such as an office building, restaurant, shop or residence so that the canopy 13 is deployed to optimize the generation of electricity from the sunlight by the photovoltaic cells and the cooling of the structure, such as at the roof, windows or doorways, due to the shading from the sun created by the canopy 13.

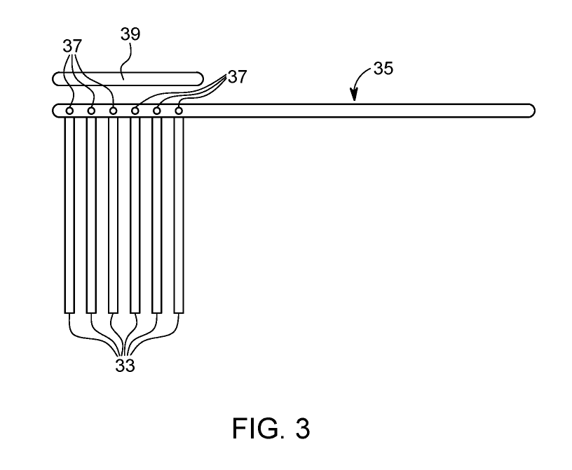

Referring to FIG. 2, another embodiment of the system of the present invention is illustrated at 29 which uses a retractable electrical energy producing sunshade canopy shown at 31 comprising a plurality of rigid solar panels 33 that can be unfolded to a deployed position as shown in FIG. 2 and folded to a stored position as shown in FIG. 3. In this embodiment, each of the rigid solar panels 33 is rotatable about an axis 37 and slideably mounted on a canopy deployment mechanism generally shown at 35 that is erected at the area to be shaded.

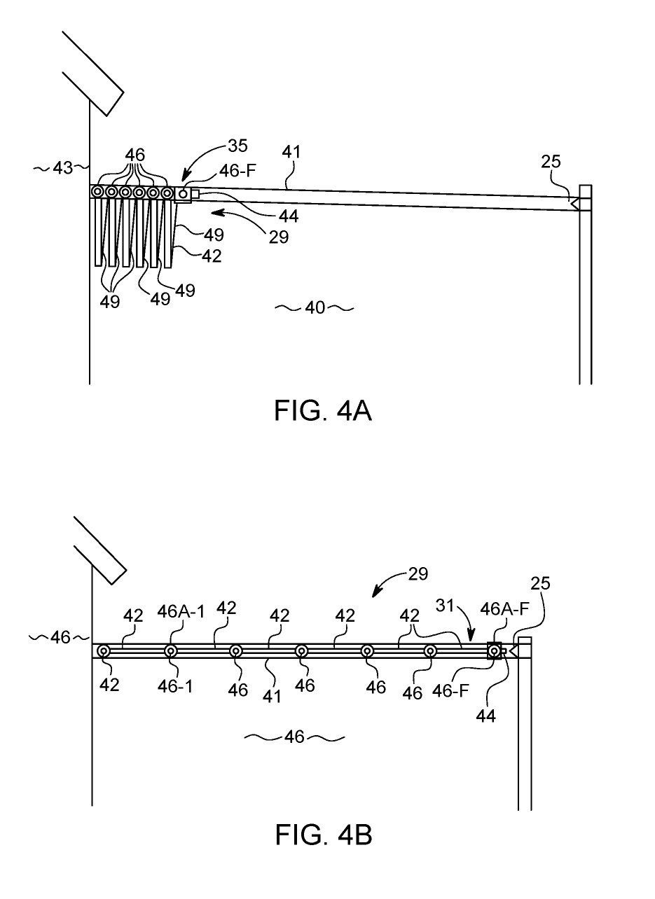

In order to retract the canopy 31, the rigid solar panels 33 are rotated so that they are perpendicular to the longitudinal axis of the canopy deployment mechanism 35 and the rigid solar panels 33 are moved by the canopy deployment mechanism 35 and collected at one end thereof so they are flat against or adjacent to one another as best shown in FIG. 3. A shield 39 can be provided over the solar panels 33 when in the stored position so that the panels 33 are protected from the elements. The canopy deployment mechanism 35 can be supported by a retractable frame similar to the embodiment shown in FIG. 1 or fixed permanently in place. Referring to FIG. 4 through FIG. 7, one embodiment of the canopy deployment mechanism 35 will now be explained in detail. Referring to FIG. 4A and FIG. 4B which show the system 29 in the stored, and fully deployed positions respectively, a track system 41 is positioned over the area 40 to be shaded such as a porch, patio, deck, swimming pool or dining area or externally at a window, roof or door of a structure 43 and/or where the system is to be operated, such as on a roof of the structure 43. Rigid solar panels 42 which form the electrical energy and shade producing canopy 31 are supported by the track system 41 and are pulled up to the horizontal position by ropes 49 that wrap around axles 46 as they rotate while being rolled to their respective deployed positions along the track system 41 as shown in FIG. 4B.

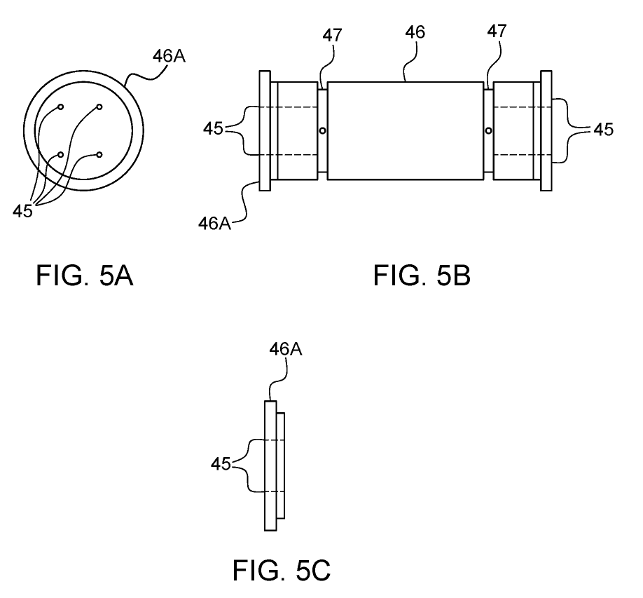

The axles 46 have wheels 46A (as best seen in FIG. 5A through FIG. 5C) that are supported on the track system 41 and the wheels 46A are fixed directly to the axle 46 (and not to a hub assembly), for example, via screw fasteners threaded through holes 45 so that the wheels 46A and axle 46 move dependently and proportionately to one another. Each axle 46 has grooves 47 for receiving the ropes or chains 49 that are attached to the solar panels 42 and wrap and unwrap around the axles 46 to move the solar panels 42 between the horizontal and vertical positions as will be more fully explained below.

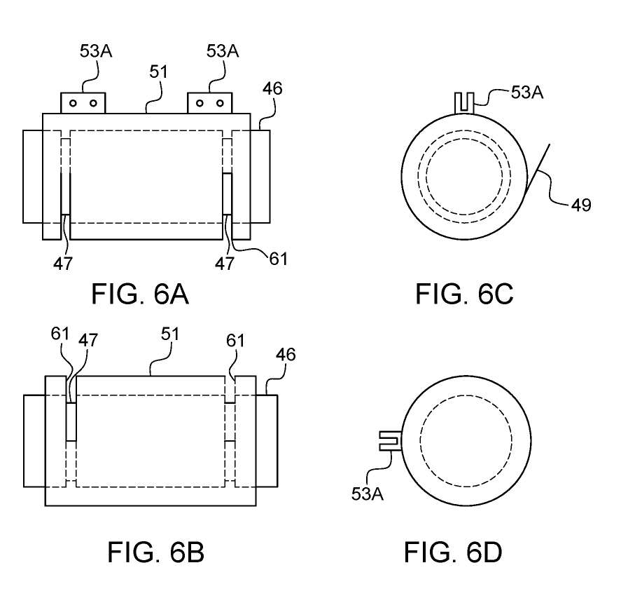

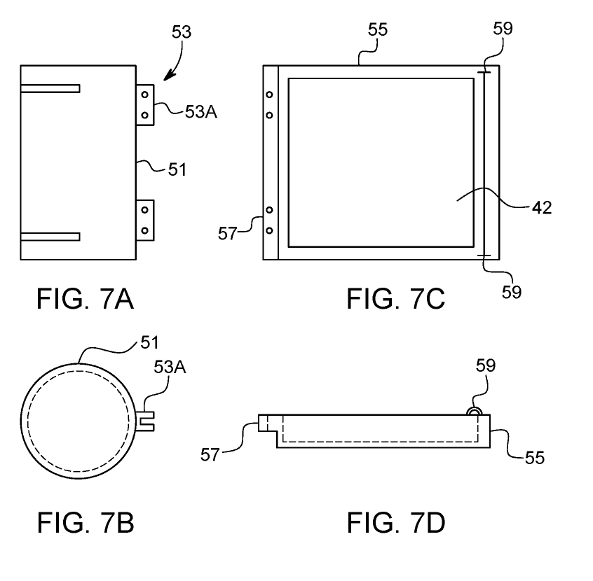

Front drive axle 46-F is attached to a driver 44 for rotating the drive axle 46-F either forward or backward to move the front axle 46-F back and forth along the track 41 between the stored position shown in FIG. 4A and the deployed position shown in FIG. 4B. The driver 44 comprises for example an electric motor or hand crank for rotating the front drive axle 46-F in either direction or a draw string for pulling the front axle 46-F back and forth along the track 41. As best shown in FIG. 6A and FIG. 6B, on each axle 46 except the front drive axle 46-F is rotatably mounted a sleeve 51 so as to move independently of the axle and wheel assembly 46,46A. Each of the sleeves 51 have an attachment arrangement at 53 for attaching the sleeve 51 to a solar panel support frame 55 that supports the rigid solar panel 42 as shown in FIG. 7A through FIG. 7D. The attachment arrangement 53 comprises for example a pair of channel members 53A on each of the sleeves 51 having a channel sized to receive the edge 57 of the solar panel support frame 55 in a supportive manner. Complementary holes are provided, for example, for receiving screw fasteners to attach the sleeve 51 rigidly to the support frame 55 when the edge 57 is inserted in the channel members 53A. As best seen in FIG. 7C and FIG. 7D, the frame 55 also has loops 59 for attaching the ropes 49 to the solar panel support frame 55. Each sleeve 51 has two slits 61 that expose the grooves 47 on axle 46 the sleeve 51 surrounds. One end of the ropes or chains 49 run from the loops 59 on hanging end of the solar panel support frame 55 (when in the vertical position) and attach to the axle 46 in front of it through the slits 61 in the sleeve 52. As the axle 46 rolls forward, the rope 49 winds itself around the axle 46 in the groove 47 as shown in FIG. 6C and FIG. 6D, drawing the hanging end of the solar panel support frame 55 up into a horizontal position as best shown in FIG. 4B to form the canopy 31. The length of each rope or chain 49 must equal the total rotational distance it will travel as it wraps around the axle 46 that is necessary to draw the solar panels 42 up to the horizontal position and cannot be less than the total length of the solar panel support frame assembly 55.

In that regard, the circumference of the axle 46 where the rope 49 winds around relative to the total travel distance of the wheel 46A along the track 41 must be determined separately for each axle 46. For example, referring to FIG. 4B, assuming: 1) the first wheels 46A-1 supporting axle 46-1 only travels a total of 28 inches along the track 41 in order to reach the deployed position, 2) the circumference of the wheels 46A are 28 inches and 3) the rope 49 must be retracted 28 inches in order to pull the solar 42 up to the horizontal position, then the circumference where the rope 49 winds around the axle 46 must be equal to the circumference of the first wheel 46A-1, i.e. 28 inches. However, if the front wheels 46A-F which support the drive axle 46-F of the system 29 must travel a total of 168 inches in order to each the deployed position then in order to retract the rope 28 inches to pull the solar panel 42 up to the horizontal position, the circumference of the front drive axle 46-F where the rope 49 winds can only be ⅙ the circumference of the front wheels 46A-F because the front drive axle 46-F takes a total of six revolutions to reach its deployed position. Thus, the circumference of the drive axle 46-F associated with the front wheels 46A-F can only be 4.667 inches.

In operation the driver 44 rotates the front drive axle 46-F forward from the stored position shown in FIG. 4A and as the front axle 46-F rolls along the track 41 towards its deployed position as shown in FIG. 4B, rope 49 wraps around the axle 46-F and pulls the solar panel 42 in support frame 55 attached to the axle 46 behind the front axle 46-F up to the horizontal position. As the front drive axle 46-F continues to move along the track 41, it pulls each axle 46 along behind it. As the axles 46 rotate, the associated ropes 46 wind around them and pull the solar panel 42 in the support frame 51 attached to the axle 46 behind them up to the horizontal position once all the axles 46 have reached the deployed position as shown in FIG. 4B. By reversing the driver 44, the drive axle 46-F pushes the other axles 46 back toward the stored position and the panels 42 are heavy enough to unwind the ropes 49 on the axles 46 as the tension is released.

When the driver 44 is an electric motor, a microcontroller is employed to control the forward and backward rotation of the electric motor and is preferably connected to a motion sensor 25 for sensing the position of the front drive axle 46-F during deployment and retraction and to determine the shade canopy's location. The motion sensor 25 can also be used by the microcontroller's logic to assist in positioning the canopy at pre-set, stop-locations as well as emergency stop features for safety.

As with the embodiment of the system described in regard to FIG. 1, the deployment and retraction of the system 29 can be automated using the microcontroller to control the motor and the motion of driver 44 along the track 49 to open and close the system 29 automatically. The microcontroller can be provided with logic programming and connected to inputs from sensors such as a timer, temperature sensor, light sensor and/or wind sensor to optimize electrical generation and cooling from shade based on current conditions as well as to retract the system to prevent damage from hazardous weather conditions. In addition, the canopy deployment mechanism 35 can be computer controlled and integrated into the heating/cooling system (not shown) of the structure such as an office building, restaurant, shop or residence so that the canopy 31 is deployed to optimize the generation of electricity from the sunlight by the photovoltaic cells and the cooling of the structure, such as at the roof, windows or doorways, due to the shading from the sun created by the canopy.

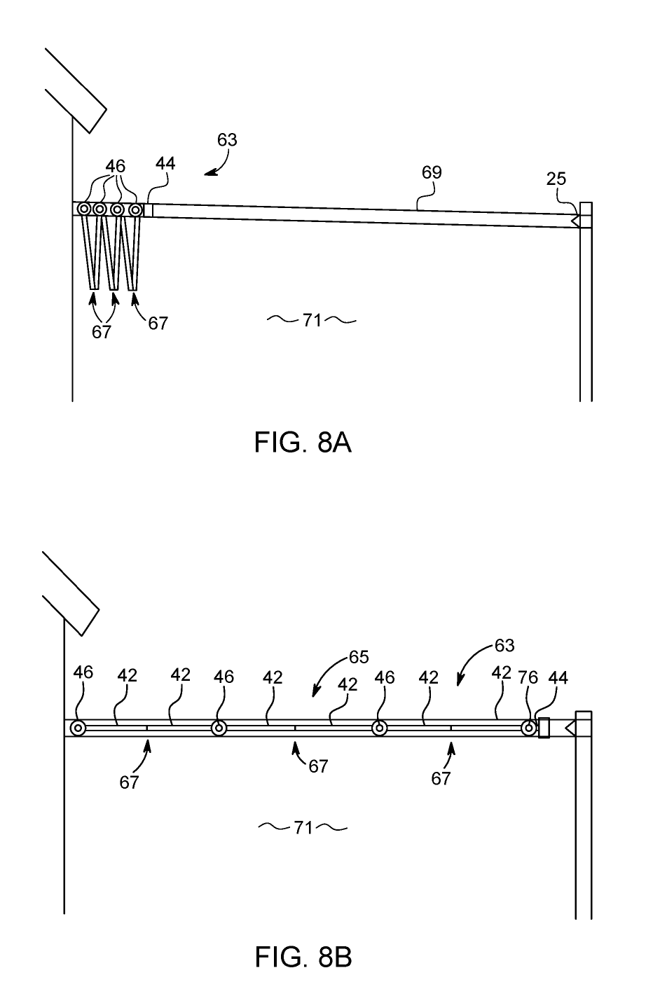

FIG. 8 though FIG. 10 illustrate yet another embodiment of a rigid solar panel system at 63 in accordance with the teaching of the present invention. As best seen in FIG. 8A and FIG. 8B, the system 63 uses a solar shade canopy at 65 for producing shade and electrical energy from sunlight that comprises a plurality of rigid solar panels 42 that are supported on rotatable axles 46 at one end and hinged at 67 together in pairs at the other end. The canopy 65 is unfolded to a deployed position as shown in FIG. 8B and folded to a stored position as shown in FIG. 8A in an accordion-like manner under the control of a driver 44 that pulls or pushes the axles 46 along a track 69 that is erected over the area 71 to be shaded.

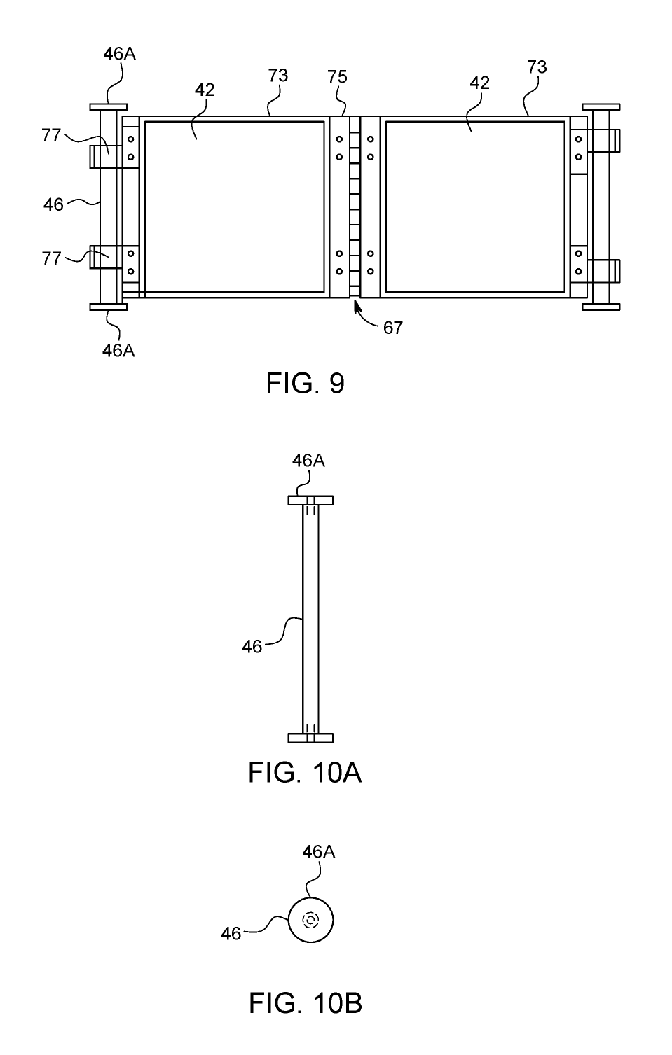

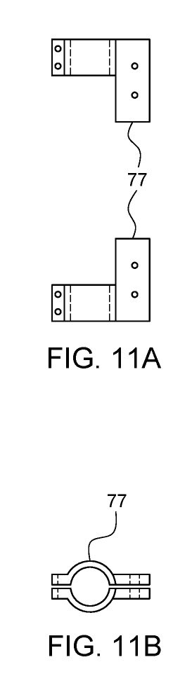

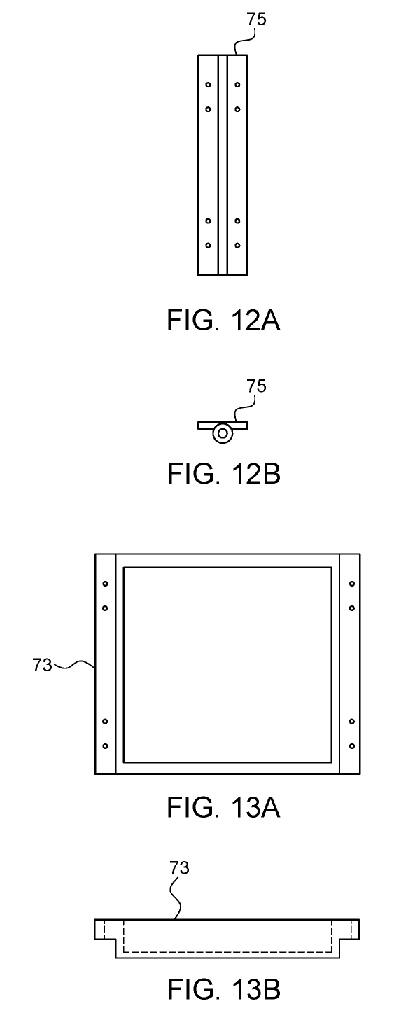

As best seen in FIG. 9 and FIG. 13, the pair of rigid solar panels 42 are each individually supported by solar panel support frames 73, as shown in top view in FIG. 13A and side view in FIG. 13B that are hinged together at 67 by a hinge 75 as shown in top view in FIG. 12A and side view in FIG. 12B that is attached to each of the frames 73 by, for example, screw fasteners. Opposite ends of the support frames 73 are rotatably attached by attachment members 77 as shown in top view in FIG. 11A and side view in FIG. 11B to axles 46 having wheels 46A as shown in top view in FIG. 10A and side view in FIG. 10B that roll on the track 69 as shown in FIG. 8A and FIG. 8B. In order to permit unobstructed folding of the solar panels 42, the attachment members 77 on one side of the pair of solar panels 42 are spaced closer to the wheels 46A then the attachment members 77 on the other side of the pair of solar panels 42 as shown in FIG. 9 so the attachment members 77 to do not interfere with one another when the panels are in the folded position. Snap clips in the form of short flanges or tabs can be provided on the hinge that snap into place when the panels are in the horizontal position to prevent sagging at the hinge. The system 63 is operated in substantially the same manner as the rigid solar panel system 29 described above.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims.

While the invention has been described by reference to these certain preferred embodiments, it should also be understood that the patentable scope of the invention is defined in the claims, and may include other examples that occur to those skilled in the art. Accordingly, it is intended that the invention not be limited by the embodiments disclosed herein, but that it have the full scope permitted by the language of the following claims.

What is claimed is:

1. A system for producing shade and generating electricity comprising:
a retractable solar shade canopy made of a material for producing a shaded area, the shade canopy material including at least one photovoltaic cell for generating electricity from sunlight; and
a canopy deployment and storage mechanism having a driver for moving the retractable solar shade canopy between a retracted stored position and a deployed position for producing a shaded area and generating electricity from sunlight.

2. A system according to claim 1, further including a canopy protector for protecting the canopy from harsh weather conditions when in the stored position.

3. A system according to claim 1 further including a grid tie inverter connected to the at least one photovoltaic cell of the shade canopy.

4. A system according to claim 1, further comprising a battery for storing charge from the at least one photovoltaic cell of shade canopy and a charge controller connected to the photovoltaic cell for controlling the charge provided by the cell to the battery.

5. A system according to claim 1, wherein the shade canopy is made from flexible material and the at least one photovoltaic cell is a flexible photovoltaic cell.

6. A system according to claim 5, wherein the canopy deployment and storage mechanism comprises a roller on which the flexible canopy is wound to the stored position and unwound to the deployed position under the control of the driver for rotating the roller forward and backward.

7. A system according to claim 6, wherein the driver is one of a hand crank for rotating the roller forward and backward.

8. A system according to claim 6, wherein the driver is an electric motor controlled by a microcontroller.

9. A system according to claim 8, further comprising at least one sensor for sensing the current conditions and the microcontroller has logic for controlling the motor to automatically deploying or retracting the shade canopy depending on the input from the at least one sensor.

10. A system according to claim 1, wherein the retractable electrical energy producing sunshade canopy comprising a plurality of rigid solar panels that are unfold to the deployed position and fold to a stored position by the deployment mechanism.

11. A system according to claim 10,
wherein the deployment mechanism comprises a railing structure erected over the area to be shaded on which the plurality of rigid solar panels are rotatably and slideably mounted at one end thereof;
wherein, in the stored position, the rigid solar panels are rotated substantially parallel to one another so that they hang down from the railing structure and collected by the deployment mechanism at one end of the railing structure so they are adjacent to one; and
wherein the rigid solar panels are rotated up to the horizontal position and slide along the railing structure to the deployed position by the deployment mechanism to form the shade canopy over the shaded area.

12. A system according to claim 1, wherein the retractable electrical energy producing sunshade canopy comprising a plurality of rigid solar panels that are hinged together and unfold to the deployed position and fold to a stored position by the deployment mechanism in an accordion-like manner.

13. A system according to claim 1, wherein the shaded area is one of a porch, patio, deck, swimming pool, dining area, window, roof and door.

14. A system according to claim 1, wherein the driver is an electric motor which is connected to a microcontroller having logic to control the forward and backward rotation of the electric motor during deployment and retraction of the canopy; and wherein the microcontroller is connected to a position sensor for sensing the position of the canopy during deployment and retraction and to determine the shade canopy's location.

15. A system according to claim 14, wherein the microcontroller's logic positions the canopy at pre-set, stop-locations based on inputs from the position sensor and includes emergency stop features for safety.

16. A system according to claim 14, wherein the deployment and retraction of the system is automated using the microcontroller to control the position of the shade canopy in accordance with the logic programming and wherein the microcontroller receives inputs from at least one sensor including a time sensor, a temperature sensor, a light sensor and a wind sensor which is used by the logic programming to control the deployment of the shade canopy to optimize electrical generation and cooling from shade based on current conditions and to retract the shade canopy to prevent damage from hazardous weather conditions.

17. A method for producing shade to cool a shaded area and for generating electricity from sunlight, the method comprising the steps of;
1) deploying a retractable solar shade canopy to create a shaded area, the canopy having at least one photovoltaic cell for producing electricity from light;
2) utilizing the deployed canopy to generate electricity from the at least one photovoltaic cell and to cool the shaded area from the light; and
3) retracting the canopy to a stored protected position when desired.

18. A method according to claim 17, further comprising the step of deploying the solar shade canopy to optimize the generation of electricity and cooling of the shaded area based on current weather conditions.

19. A method according to claim 17, further comprising the step of retracting the canopy to the stored protected position to prevent damage from hazardous weather conditions.

20. A system using a retractable solar shade canopy made from one or more flexible sheets having flexible photovoltaic cells wherein the sunshade canopy is retractably positioned internally or externally at a window of a building or is a retractable awning positioned over a space outside and adjacent to a structure, including a porch, patio, deck, swimming pool, roof or dining area or externally at a window or door of the structure.
